(19) United States
(12) Patent Application Publication
(10) Pub. No.: US 2023/0074231 A1
(43) Pub. Date: Mar. 9, 2023

(54) INFORMATION PROCESSING APPARATUS, METHOD AND SYSTEM

(71) Applicant: IPCO 2012 LIMITED, London (GB)

(72) Inventors: Mostafa Hussein SABET, Singapore (SG); Phoebe TAN, Flitwick (GB); Mark Elliott COLSTON, Watford (GB)

(21) Appl. No.: 17/941,350

(22) Filed: Sep. 9, 2022

(30) Foreign Application Priority Data
Sep. 9, 2021 (GB) 2112854.1

(51) Int. Cl. G06Q 20/38; G06Q 20/02

(52) U.S. Cl. CPC G06Q 20/385; G06Q 20/027

(57) ABSTRACT

An information processing system for associating a first party and a second party can include a second information processing apparatus that receives a message from a first information processing apparatus comprising information identifying the second party; generates a code associated with the second party; transmits a message comprising the code to the first information processing apparatus; receives a message comprising the code and information identifying the first party from a third information processing apparatus that receives an authentication credential from the first party; associates the first and second parties; transmits a message comprising information indicating the association of the first and second parties to the third information processing apparatus; receives a message comprising information indicating the approval of the association by the first party from the third information processing apparatus; and transmits a message comprising information indicating the approval of the association to the first information processing apparatus.

### TECHNICAL FIELD

The present disclosure relates to an information processing apparatus, method and system.

### BACKGROUND

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

It is sometimes necessary for information processing operations to be performed by a first party on behalf of a second party. Sometimes, performing the information processing operation requires sensitive information of the second party to be shared with the first party. This requires the second party to trust the first party. If the second party does not trust the first party and therefore doesn't share the sensitive information, the information processing operation cannot be performed. A system which does not require this trust whilst maintaining security of the sensitive information of the second party is therefore desirable.

### BRIEF SUMMARY

An information processing system for associating a first party and a second party can include: a first information processing apparatus; a second information processing apparatus; and a third information processing apparatus. The second information processing apparatus can be configured to: receive a message from the first information processing apparatus comprising information identifying the second party; generate a code associated with the second party; and transmit a message comprising the code to the first information processing apparatus. The third information processing apparatus can be configured to: receive an authentication credential from the first party; obtain the code; transmit a message comprising the code and information identifying the first party to the second information processing apparatus. The second information processing apparatus can be further configured to: associate the first and second parties; and transmit a message comprising information indicating the association of the first and second parties to the third information processing apparatus. The third information processing apparatus can be further configured to: receive approval of the association from the first party; and transmit a message comprising information indicating the approval of the association to the second information processing apparatus. The second information processing apparatus can be further configured to transmit a message comprising information indicating the approval of the association to the first information processing apparatus.

### BRIEF DESCRIPTION OF THE DRAWINGS

Non-limiting embodiments and advantages of the present disclosure will be best understood by reference to the following detailed description taken in conjunction with the accompanying drawings, wherein:

FIGS. 1A-C show, respectively, a first, second and third information processing apparatus according to an embodiment;

FIG. 2 shows an example information processing system in which the information processing apparatuses of FIGS. 1A-C may be implemented according to an embodiment;

FIGS. 3A-E show example screens of a mobile banking application according to an embodiment;

FIG. 4 shows steps for associating a consumer's bank account with a merchant according to an embodiment;

FIG. 5 shows steps of a merchant requested transaction (MRT) payment according to an embodiment;

FIG. 6 shows steps of a combined association and MRT payment process;

FIG. 7 shows, more generally, an information processing method according to an embodiment;

FIG. 8 shows an information processing method of the first information processing apparatus;

FIG. 9 shows an information processing method of the second information processing apparatus;

FIG. 10 shows an information processing method of the third information processing apparatus;

FIG. 11A-11C show example screens of the MBA and merchant native app displayed on a display 301 of a terminal device 300 of a consumer (user) during some of the steps associated with the disassociation according to embodiments; and

FIG. 12 shows a signal flow diagram explaining the process for deleting the association.

Like reference numerals designate identical or corresponding parts throughout the drawings.

### DETAILED DESCRIPTION

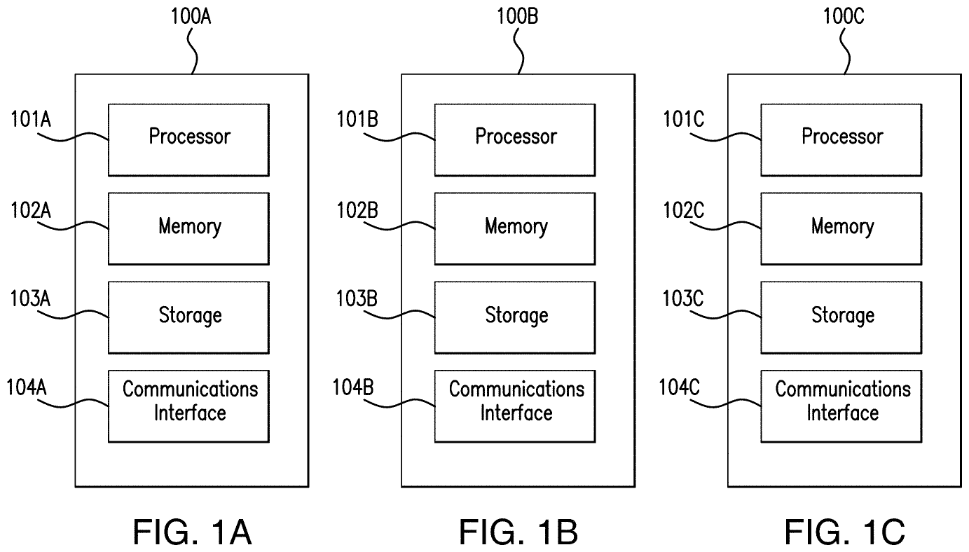

FIGS. 1A-C show, respectively, a first, second and third information processing apparatus (device).

The first information processing device 100A comprises a processor 101A for processing electronic instructions, a memory 102A for storing the electronic instructions to be processed and input and output data associated with the electronic instructions, a storage medium 103A (e.g., in the form of a hard disk drive, solid state drive, tape drive or the like) for long term storage of electronic information and a communications interface 104A for sending electronic information to and/or receiving electronic information from one or more of the other information processing devices (e.g., information processing devices 100B and/or 100C). Each of the processor 101A, memory 102A, storage medium 103A and communications interface 104A are implemented using appropriate circuitry, for example. The processor 101A controls the operation of each of the memory 102A, storage medium 103A and communications interface 104A.

The second information processing device 100B comprises a processor 101B for processing electronic instructions, a memory 102B for storing the electronic instructions to be processed and input and output data associated with the electronic instructions, a storage medium 103B (e.g., in the form of a hard disk drive, solid state drive, tape drive or the like) for long term storage of electronic information and a communications interface 104B for sending electronic information to and/or receiving electronic information from one or more of the other information processing devices (e.g., information processing devices 100A and/or 100C). Each of the processor 101B, memory 102B, storage medium 103B and communications interface 104B are implemented using appropriate circuitry, for example. The processor 101B controls the operation of each of the memory 102B, storage medium 103B and communications interface 104B.

The third information processing device 100C comprises a processor 101C for processing electronic instructions, a memory 102C for storing the electronic instructions to be processed and input and output data associated with the electronic instructions, a storage medium 103C (e.g., in the form of a hard disk drive, solid state drive, tape drive or the like) for long term storage of electronic information and a communications interface 104C for sending electronic information to and/or receiving electronic information from one or more of the other information processing devices (e.g., information processing devices 100A and/or 100B). Each of the processor 101C, memory 102C, storage medium 103C and communications interface 104C are implemented using appropriate circuitry, for example. The processor 101C controls the operation of each of the memory 102C, storage medium 103C and communications interface 104C.

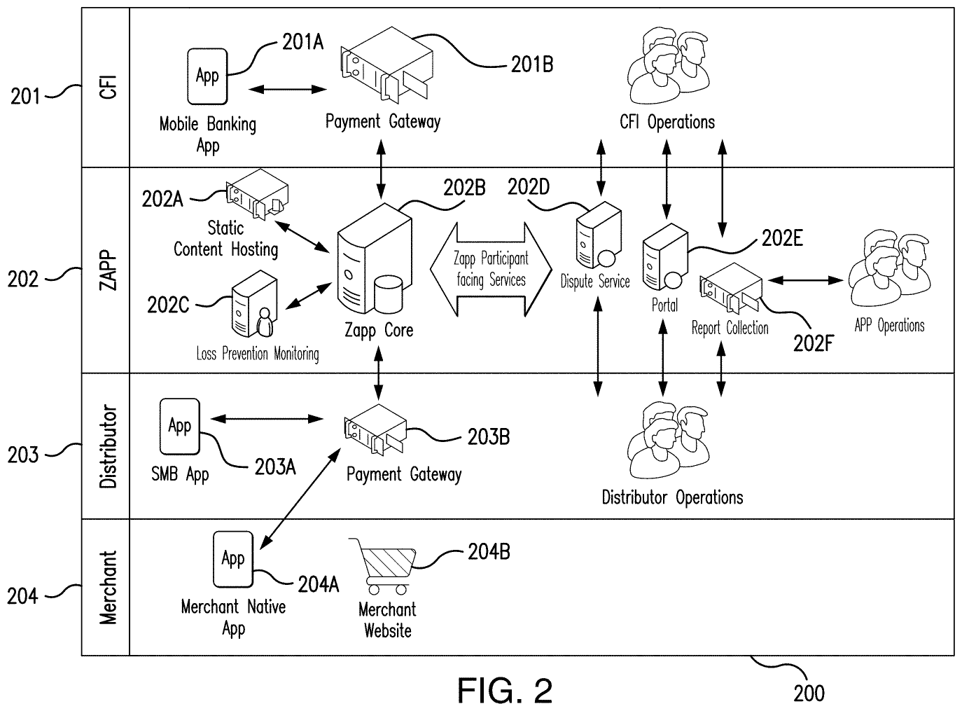

FIG. 2 shows an example information processing system 200 in which the information processing devices 100A-C are implemented. Different parts of the system are associated with different parties. The parties are a Corporate Financial Institute (CFI) 201 (which may be referred to as a financial institution), a payment provider (Zapp) 202 which allows direct electronic payment from a consumer's bank account to a merchant's bank account as an alternative to a credit or debit card payment (this is known as a “Pay by Bank App” (PBBA) service), a distributor 203 which enables a merchant to take electronic payments from a consumer (e.g., by providing secure check out functionality) and a merchant 204.

The parts of the system associated with the CFI 201 are a mobile banking app (MBA) 201A and a payment gateway 201B.

The MBA 201A is an application installed on a terminal device (e.g., smartphone or tablet computer) of a consumer which allows the consumer to connect directly to the CFI to access banking functionality and in addition (where offered) PBBA services. The CFI can issue multiple MBAs that have PBBA embedded. This can be based on how the CFI segments its customers, for example a premium brand consumer segment or a payment focused consumer app.

The gateway 201B supports one or more MBAs and integrates with a Zapp Core 202B of the payment provider 202 to facilitate PBBA activation and transactions. The gateway also communicates with CFI's account management and risk management systems to authorize transaction and initiate settlement. The gateway 201B comprises the third information processing device 100C.

The parts of the system associated with the payment provider 202 are the Zapp Core 202B, a participant portal 202E, report collection 202F, static content hosting 202A, a dispute service 202D and loss prevention monitoring 202C.

The Zapp Core 202B includes the systems, application and processes used by the payment provider to process PBBA transactions and refunds, maintain consumer records and log interactions. The Zapp Core 202B comprises the second information processing device 100B.

The participant portal 202E is accessible to other participants of the system (including the CFI 201 and distributor 203) and is through which the payment provider 202 makes available information and operational services in relation to PBBA.

Report collection 202F collects operational reports for use by other participants of the system (including the CFI 201 and distributor 203).

The dispute service 202D allows access to a disputes portal to manage workflow of disputes between other participants of the system (including the CFI 201 and distributor 203).

Loss prevention monitoring 202C provides continuous real-time risk analysis and assessment of merchant and consumer behaviour associated with transactions. It may provide risk scores about transactions (to allow potentially fraudulent transactions to be investigated). Ultimately, the decision to authorize a payment remains with the CFI

The parts of the system associated with the distributor 203 are an SMB app 203A and a payment gateway 203B.

The SMB app 203A is an application issued to the merchant 204 through their business bank or distributor service. It is installed on a terminal device (e.g., smartphone or tablet computer) to allow the terminal device to act as a mobile point of sale device.

The payment gateway 203B provides the Merchant with technical connectivity to the Zapp Core 203B and enables the processing of PBBA transactions. The payment gateway 203B comprises the first information processing apparatus 100A.

The parts of the system associated with the merchant 204 are a merchant native app 204A and/or a merchant website 204B.

The merchant native app 204A is an application installed on a terminal device (e.g., smartphone or tablet computer) of a consumer which allows a consumer to purchase products from the merchant online. The Merchant Native App 204A includes a check out page with PBBA as a payment option. The check out page functionality is provided by the distributor 203.

The merchant website 204B is a website which allows a consumer accessing the website to purchase products from the merchant online. It may exist in addition to or instead of the merchant native app 204A. The merchant website includes a check out page with PBBA as a payment option. The checkout page functionality is provided by the distributor 203.

The system 200 allows a consumer to securely make purchases from a merchant using PBBA instead of a credit or debit card. These may be one time purchases or purchases which are repeatedly made on a regular basis (e.g., a monthly subscription to receive a service). Currently, each time a purchase is made, the user must be actively involved in the purchase for security reasons. For example, the user may be required to authorize the purchase by providing suitable credentials (e.g., a passcode or biometric identifier) to the MBA 201A installed on their smartphone. For repeat purchases, this is inconvenient to the consumer. For example, if the user pays for a monthly subscription service using PBBA, they will need to authorize the payment every month. Alternatively, the user may allow the merchant to charge them monthly without further authorization from the user. However, to do this, the user may have to share sensitive information with the merchant (e.g., bank account details) so as to allow the PBBA authorization to be bypassed. This is undesirable as it requires the consumer to trust the merchant with the sensitive information and the consumer may have no guarantee the merchant is trustworthy.

To address this problem, the present technique allows an association between a merchant and a consumer to be established which allows multiple payments to be made from the consumer to the merchant without the need for consumer authorization but does not require sensitive information to be revealed to the merchant. This provides improved convenience to the user whilst maintaining the security of the system.

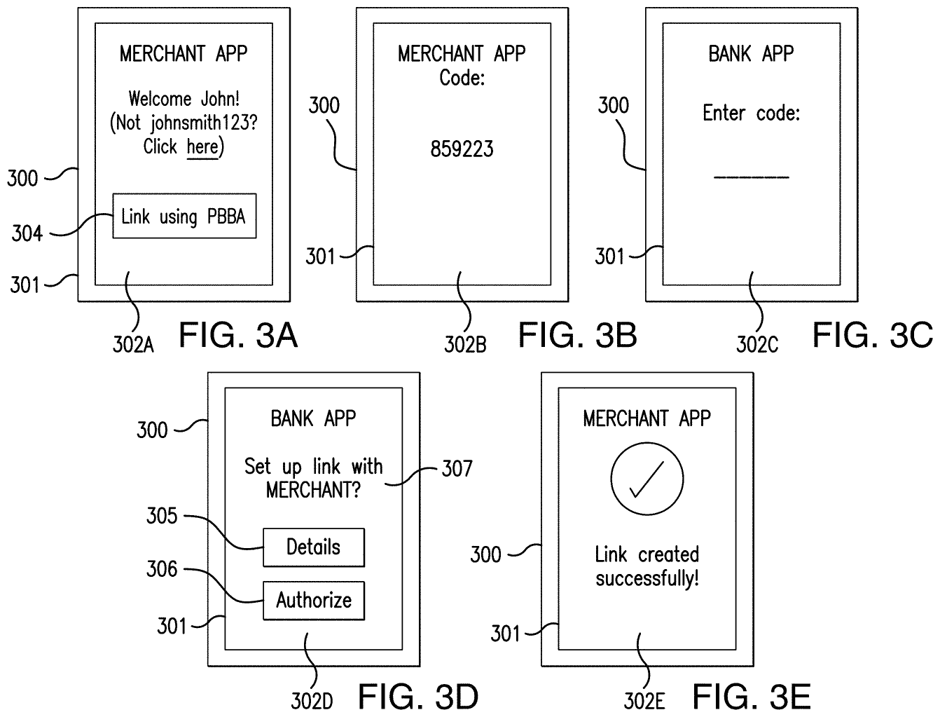

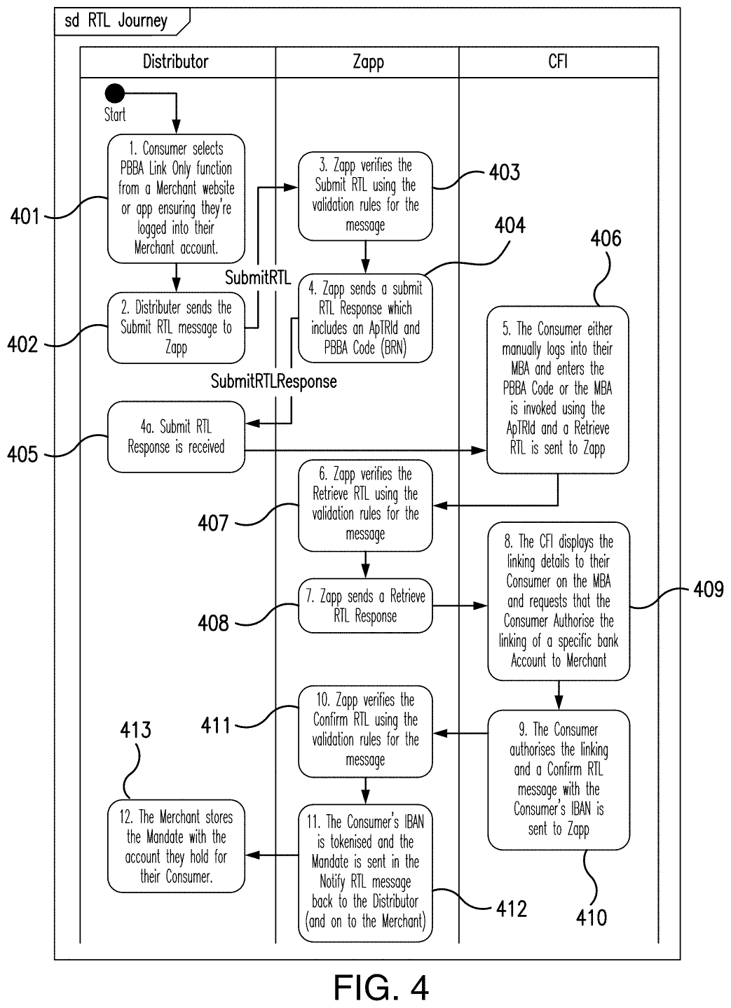

The setting up of the association is demonstrated by FIGS. 3A-E and FIG. 4. FIG. 4 shows steps of a process for setting up the association. FIGS. 3A-E show example screens of the MBA 201A and merchant native app 204A displayed on a display 301 of a terminal device 300 of a consumer (user) during some of the steps.

At step 401, the consumer, who has previously logged into an account they have with the merchant using the merchant native app, selects a “Link using PBBA” virtual button 304 shown on a first screen 302A of the merchant native app (FIG. 3A). The consumer is called “John” and has a username “johnsmith123” which uniquely identifies the account with the merchant. The consumer will have previously logged in using the username and a passcode or biometric identifier, for example. Pressing the virtual button 302 allows the consumer to review a merchant agreement which informs them that they are linking their account to allow the merchant to request transactions based on the merchant agreement. Such a transaction is referred to as a merchant requested transaction (MRT) and is a transaction which may be requested by the merchant to initiate the transfer of funds from the consumer's bank account to the merchant's bank account without further authorization from the consumer. After the consumer has reviewed and accepted the terms of the merchant agreement, the consumer confirms the linking (e.g., by selecting a “confirm link” virtual button (not shown)).

At step 402, in response to the consumer confirming the linking, the native merchant app 204A sends a “Submit RTL” message to the Zapp Core 202B via payment gateway 203B (RTL stands for “Request to Link”). The Submit RTL message comprises a request to authorize a subsequent Merchant Requested Transaction.

At step 403, the Zapp Core 202B verifies the Submit RTL message using predetermined validation rules for the message.

At step 404, in response to successfully verifying the Submit RTL message, the Zapp Core 202B sends a “Submit RTL Response” message back to the payment gateway 203B. The Submit RTL Response message comprises a PBBA code associated with the request of the Submit RTL message. For example, the PBBA code is a one-time code generated by the Zapp Core 202B. The one time code is limited in size and complexity to enable easy manual entry by the consumer. Once the process of FIG. 4 is complete, the specific PBBA code may be used again for a different Submit RTL message request (although the generation of PBBA codes uses, for example, a suitable pseudorandom technique so PBBA codes cannot be easily predicted). Alternatively or in addition, the Submit RTL Response message comprises an “ApTRId” identifier. Like the PBBA, the ApTRId identifier is a code generated by the Zapp Core 202B and associated with the request of the Submit RTL message. The ApTRId identifier may be longer and more complex than the PBBA code as it does not require manual entry by a consumer (rather, it is processed electronically). The greater length and complexity of the ApTRId identifier means the use of a specific ApTRId need not be repeated.

At step 405, the Submit RTL Response message is received by the consumer's terminal device from the payment gateway 203B. In this example, the PBBA code comprised within the Submit RTL Response message is displayed on a second screen 302B of the merchant native app (FIG. 3B). The PBBA code in this case is “859223”.

At step 406, the consumer opens the MBA associated with the bank account they wish to link with the merchant. The MBA may be opened automatically by the consumer's terminal device in response to receiving the Submit RTL Response message (or if the user has multiple MBAs installed, they are asked to make a selection of the MBA associated with the bank account they wish to link). On a first screen 302C of the MBA (which they may navigate to using suitable menus or the like), they are prompted to enter the PBBA code (FIG. 3C). The user enters the PBBA code “859223” displayed on the second screen 302B of the native merchant app. A “Retrieve RTL” message comprising the entered PBBA code is then sent to the Zapp Core 202B via the payment gateway 201B. Alternatively, if the ApTRId identifier is used, there is no need for the user to manually enter the PBBA code. In this case, the presence of the ApTRId identifier in the Submit RTL Response message causes the MBA on the consumer's terminal device to automatically generate a Retrieve RTL message comprising the ApTRId identifier. Whether the PBBA code or the ApTRId identifier is used is selectable by the user and/or CFI associated with the MBA, depending on their preferences.

At step 407, the Zapp Core 202B verifies the Retrieve RTL message using predetermined validation rules for the message.

At step 408, in response to successfully verifying the Retrieve RTL message, the Zapp Core 202B sends a “RTL Response” message to the MBA 201A via the payment gateway 201B. The RTL Response message comprises information identifying the merchant and the fact that a link between the merchant and consumer's bank account has been proposed. Additional information associated with the proposed link (e.g., the maximum value of any MRT, how often an MRT may be made and any other details the consumer is agreeing to—this information represents one or more predetermined conditions which an MRT payment must satisfy and may be referred to as the “MRT mandate”) may also be included in the RTL Response message. The information identifying the merchant and the MRT mandate comprised within the RTL response message is initially comprised within the Submit RTL message transmitted or sent to the Zapp Core 202B in step 402, for example.

At step 409, information extracted from the RTL Response message is displayed on a second screen 302D of the MBA (FIG. 3D). The information includes text 307 identifying the merchant (the merchant is identified as “MERCHANT” in this example but, in reality, the merchant is named here) and asking whether the consumer wishes to link their bank account with this merchant for MRTs. The second screen 302D comprises a “Details” virtual button 305 and an “Authorize” virtual button 306. By selecting the “Details” virtual button 305, the user is able to view details of the MRT mandate.

At step 410, once the user is happy for the link to be made, they select the “Authorize” virtual button 306. Optionally, once the “Authorize” virtual button has been selected, the user may be asked to provide authentication credentials such as a passcode or biometric identifier. This provides improved security by ensuring that only the consumer is able to authorize an MRT mandate. In response to the selection of the “Authorize” virtual button (and, if present, successful verification of the consumer's authentication credentials), the MBA 201A transmits a “Confirm RTL” message to the Zapp Core 202B via the payment gateway 201B. The Confirm RTL message comprises information uniquely identifying the consumer's bank account which is to be linked to the merchant. In this example, the information is the bank account's International Bank Account Number (IBAN).

At step 411, the Zapp Core 202B verifies the Confirm RTL message using predetermined validation rules for the message.

At step 412, in response to successfully verifying the Confirm RTL message, the Zapp Core 202B generates a proxy identifier of the consumer's bank account. A “Notify RTL” message comprising the proxy identifier is then sent to the payment gateway 203B where it is securely stored for use by the distributor 203 and merchant 204.

At step 413, in response to the proxy identifier being successfully stored at the payment gateway 203B, a third screen 302E of the native merchant app informs the consumer that the link between the consumer's account and merchant has been established.

Once the link has been established, the merchant 204 may send messages to the CFI 201 via the payment gateway 203B, Zapp Core 202B and payment gateway 201B requesting payment from the account identified by the proxy identifier. The proxy identifier can only be used by the merchant for transactions which conform to the MRT mandate. Thus, no other party can successfully request money from the consumer using the proxy identifier. Furthermore, the merchant cannot request money from the consumer in a way which does not conform to the MRT mandate (e.g., by asking for a payment value which exceeds that defined as a maximum in the MRT mandate). Payments within the terms of the MRT mandate can therefore be made from the consumer to the merchant without the inconvenience of the consumer having to manually authorize the payment but without providing sensitive information (e.g., the consumer account's IBAN) to the merchant. Consumer convenience is therefore improved whist security is maintained. In this example, the proxy identifier is a tokenised version of the consumer's IBAN.

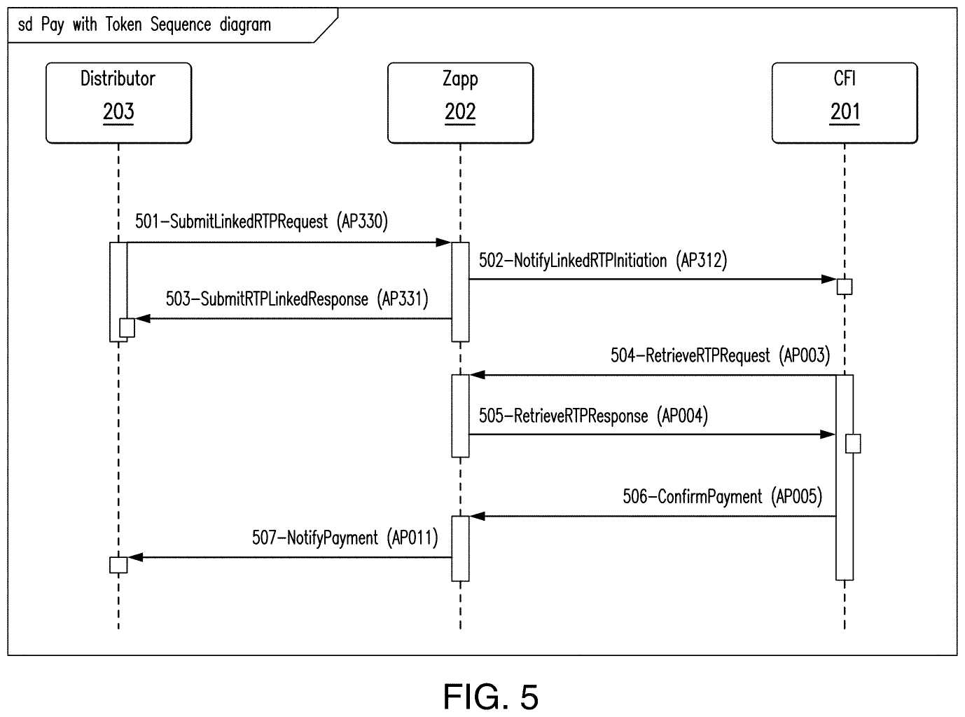

FIG. 5 shows steps of a MRT payment process using the association established in FIG. 4.

At step 501, when a payment from the consumer to the merchant 204 is to be made (e.g., at the time of the month that payment is due for a monthly subscription service or if a customer has added items to a virtual basket using the merchant native app 204A or merchant website 204B and selects to check out), the payment gateway 203B of the distributor 203 transmits a “Submit RTP” message requesting an MRT payment to the Zapp Core 202B (RTP stands for “Request to Pay”). The Submit RTP message comprises the tokenised IBAN of the consumer's linked bank account, an identifier of the merchant, a value of the payment and information indicating the MRT mandate.

At step 502, the Zapp Core 202B verifies the Submit RTP message using predetermined validation rules for the message and, in response to successfully verifying the Submit RTP message, looks up the CFI with which the tokenised IBAN is associated. When the tokenised IBAN is created by the Zapp Core 202B, the Zapp Core 202B stores information indicating an association of the tokenised IBAN and the CFI at which the account identified by the original IBAN is held. Once the CFI has been identified, the Zapp Core 202B transmits a “Notify Linked RTP initiation” message to that CFI. The Zapp Core 202B is able to send and receive electronic messages from all CFIs registered with the payment provider 202 in advance to allow MRT payments from their customer accounts. The Notify Linked TRP initiation message comprises information identifying the merchant and indicating the merchant is requesting a MRT payment. The Notify Linked TRP initiation message also comprises a further “ApTRId” identifier. The ApTRId identifier is a code generated by the Zapp Core 202B and associated with the request of the Submit RTP message of step 501. The Notifying Linked RTP initiation message is received by the payment gateway 201B of the identified CFI 201.

At step 503, after transmitting the Notifying Linked RTP initiation message to the CFI 201, the Zapp Core 202B transmits a “Submit RTP Response” message back to the payment gateway 203B to inform the merchant 204 and distributor 203 that the tokenised IBAN was successfully found and that the Notifying Linked TRP initiation message was successfully sent.

At step 504, in response to receiving the Notify Linked TRP initiation message, the payment gateway 201B transmits a “Retrieve RTP” message back to the Zapp Core 202B via the gateway 201B. The Retrieve RTP message comprises the ApTRId associated with the request of the Submit RTP message of step 501.

At step 505, in response to receiving the Retrieve RTP message, the Zapp Core 202B sends a “Retrieve RTP Response” message back to the gateway 201B. The Retrieve RTP Response message comprises the tokenised IBAN of the consumer's linked bank account, an identifier of the merchant, a value of the payment and information indicating the MRT mandate. When the tokenised IBAN was previously generated, the CFI is informed of the tokenised IBAN. This is stored at the payment gateway 201B and associated with the non-tokenised IBAN of the consumer's linked bank account together with an identifier of the merchant for whom the tokenised IBAN was created. Based on the tokenised IBAN and merchant identified in the Retrieve RTP Response message, the CFI is thus able to check the tokenised IBAN against the merchant and, if there is a match, look up the non-tokenised IBAN to identify the bank account from which payment is to be made. Payment from the identified bank account to a bank account of the merchant (e.g., provided with the merchant identifier in the Submit RTP and Retrieve RTP response messages) is then carried out (via a suitable interbank network such as the Faster Payments® network) as long as the payment conforms to the rules of the MRT mandate.

At step 506, once the payment has been made, a “Confirm Payment” message is transmitted from the payment gateway 201B to the Zapp Core 202B. This informs the Zapp Core 202B that the payment was completed successfully.

At step 507, in response to receiving the Confirm Payment message, the Zapp Core 202B transmits a “Notify Payment” message to the payment gateway 203B informing the distributor and merchant that payment has been completed.

All steps of FIG. 5 happen without the need for any authorization by the consumer. At the same time, all the merchant knows is the tokenised IBAN. It is difficult to misuse this because the tokenised IBAN can only be used with the specific merchant for which it was created and cannot be used outside rules of the MRT mandate. Consumer security is therefore maintained whilst allowing improved convenience.

Optionally, for increased security, the user may be asked to authorize a payment in certain circumstances. For example, if an MRT payment is requested which exceeds a certain value (e.g., £100) or if the consumer's delivery address is changed (this may be indicated by a flag in the Submit RTP message of step 501, for example), the CFI, upon receiving the Retrieve RTP Response message, may seek authorization from the user via the MBA 201A (e.g., by controlling the MBA to ask for authentication credentials such as a passcode or biometric identifier) before initiating payment. Other rules (that is, one or more predetermined conditions in addition to those of the MRT mandate) may be stipulated by the user and/or the CFI to determine when additional authorization should be sought from the user. In an example, most of the time, MRT payments are processed without user intervention and are constrained by the rules of the MRT mandate. However, occasionally (e.g., one in every 5 or 10 MRT payment requests within a predetermined time period), the additional user authorization may be requested. This provides improved convenience to the user but keeps the user informed if multiple MRT payment requests are made in a short term (which could be indicative of fraud, e.g., if a merchant payment gateway 203B is hacked), thereby further improving user security.

In an embodiment, the linking exemplified in FIG. 4 and the MRT payment exemplified in FIG. 5 may be combined. This allows a user to link an account with a merchant at the same time as making a purchase from the merchant. This may be useful the first time a consumer uses a particular merchant, for example. The first purchase involves the user going through the steps of securely linking their account with the merchant and paying for the purchase. Subsequent purchases, however, will not require any intervention from the user, since the ability for MRT payments to be processed (within the constraints of the MRT mandate) will have been set up.

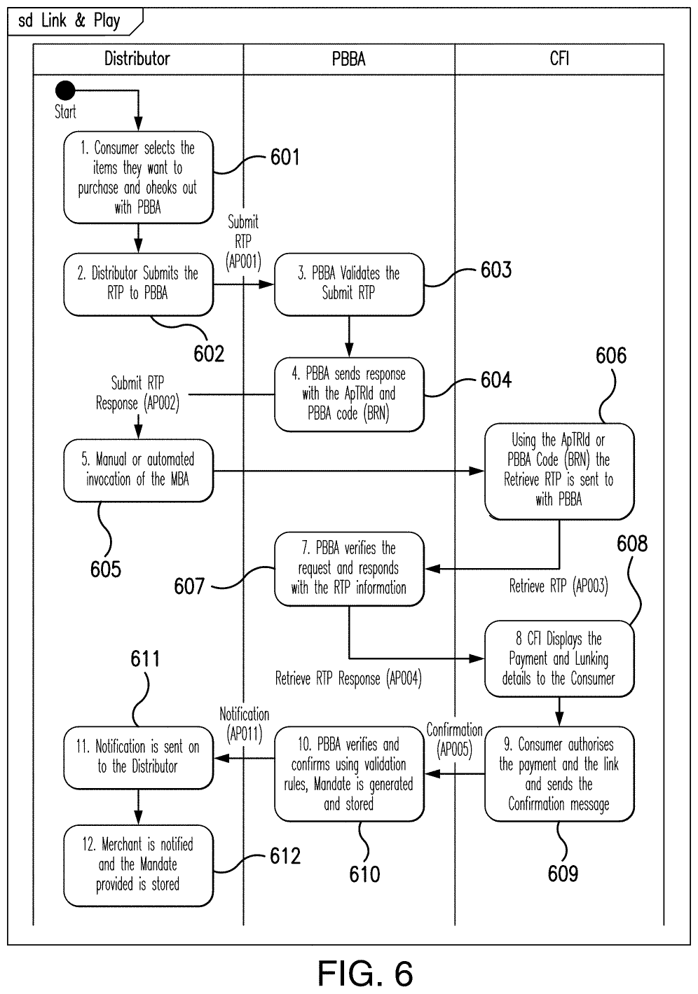

FIG. 6 shows steps of a combined MRT linking and payment process.

At step 601, the consumer, who has previously logged into the account they have with the merchant using the merchant native app, adds items to their virtual basket and chooses to check out. The user is then directed to a check out screen (not shown) which allows the user to review the selected items and to select an option to “Link and Pay using PBBA” (e.g., using a “Link and Pay using PBBA” virtual button on the check out screen). Selecting the Link and Pay using PBBA option allows the consumer to review the merchant agreement. After the consumer has reviewed and accepted the terms of the merchant agreement, the consumer confirms the linking (e.g., by selecting a “Confirm Link” virtual button (not shown)).

At step 602, in response to the consumer confirming the linking, the native merchant app 204A sends a “Submit RTP” message to the Zapp Core 202B via payment gateway 203B. The Submit RTP message comprises the request to authorize MRTs and an MRT payment request for payment for the user's selected items. The Submit RTP message comprises an identifier of the merchant, a value of the payment and information indicating the MRT mandate.

At step 603, the Zapp Core 202B verifies the Submit RTP message using predetermined validation rules for the message.

At step 604, in response to successfully verifying the Submit RTP message, the Zapp Core 202B sends a “Submit RTP Response” message back to the payment gateway 203B. The Submit RTL Response message comprises the PBBA code and/or ApTRId identifier associated with the request of the Submit RTP message.

At step 605, the Submit RTL Response message is received by the consumer's terminal device from the payment gateway 203B. The MBA 201A is then opened, either manually by the user to allow them to enter the PBBA code or automatically in response to receiving the Submit RTL response message.

At step 606, the user manually enters the PBBA code into the MBA for generation of a “Retrieve RTP” message comprising the PBBA code. Alternatively, the presence of the ApTRId identifier causes the MBA to automatically generate the Retrieve RTP message comprising the ApTRId identifier. The Retrieve RTP message comprising the PBBA code or ApTRId identifier is then sent to the Zapp Core 202B via the gateway 201B.

At step 607, the Zapp Core 202B verifies the Retrieve RTP message using predetermined validation rules for the message. In response to successfully verifying the Retrieve RTP message, the Zapp Core 202B sends a “RTP Response” message to the MBA 201A via the payment gateway 201B. The RTP Response message comprises information identifying the merchant and the fact that a link between the merchant and consumer's bank account has been proposed, the MRT mandate and the requested MRT payment amount to pay for the user's selected items. The information identifying the merchant, the MRT mandate and the requested MRT payment amount comprised within the RTP response message is initially comprised within the Submit RTP message sent to the Zapp Core 202B in step 602.

At step 608, information extracted from the RTP Response message is displayed by the MBA. The information identifies the merchant and asks whether the consumer wishes to link their bank account with this merchant for MRTs. The information also indicates the requested MRT payment amount. The user is also given the option to view details of the MRT mandate.

At step 609, once the user is happy for the link to be made and the requested MRT payment amount to be paid, they authorize the link and payment (e.g., by selecting an “Authorize” virtual button, not shown). Optionally, the authorization process comprises the user being asked to provide authentication credentials such as a passcode or biometric identifier. This provides improved security by ensuring that only the consumer is able to authorize an MRT mandate. In response to successful authorization, the MBA initiates payment of the requested MRT payment amount to the merchant (via a suitable interbank network such as the Faster Payments® network). The MBA then transmits a “Confirm” message to the Zapp Core 202B via the payment gateway 201B. The Confirm message indicates successful payment of the requested MRT payment amount and comprises the information uniquely identifying the consumer's bank account (e.g., IBAN) which is to be linked to the merchant.

At step 610, the Zapp Core 202B verifies the Confirm message using predetermined validation rules for the message. In response to successfully verifying the Confirm message, the Zapp Core 202B generates the proxy identifier of the consumer's bank account (e.g., tokenised IBAN).

At step 611, a “Notification” message comprising the proxy identifier is then sent to the payment gateway 203B where it is securely stored for use by the distributor 203 and merchant 204 for use in future MRT payments. The Notification message also indicates successful payment of the requested MRT payment amount.

At step 612, the merchant is notified that the items selected by the user have been paid for and is informed that future MRT payments within the constrains of the MRT mandate have been authorized.

Thus, with a single process, a user is able to pay the merchant and to set up an MRT mandate for future payments to the merchant which do not require payment-by-payment authorization. User convenience is therefore improved. At the same time, security is maintained because no sensitive information is shared with the merchant. Rather, only the proxy identifier is shared.

In the above-mentioned embodiments, the MRT mandate is accessible by the merchant 204 (e.g., by being stored at the gateway 203B) and the payment provider and CFI (e.g., by being stored at the Zapp Core 202B). This ensures the merchant only requests MRT payments which conform to the terms of the MRT mandate (thereby allowing them to request a conventional PBBA payment from the consumer if, for example, items are selected for purchase with a value which exceeds the maximum payment value allowed by the MRT mandate). It also ensures the payment provider and CFI only allow MRT payments which conform to the terms of the MRT mandate (thereby keeping the consumer safe from payments which have not been authorized). It will be appreciated that, more generally, the MRT mandate can be stored at one or more locations in the system 200 and messages comprising information defining the MRT mandate can be transmitted to any individual device which needs to refer to the MRT mandate.

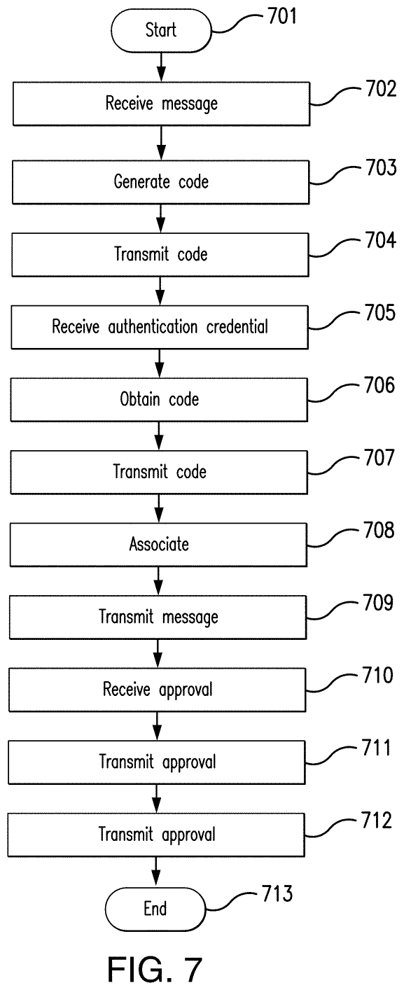

FIG. 7 shows, more generally, an information processing method according to an embodiment. The method allows a first party (e.g., consumer) to be associated with a second party (e.g., merchant).

The method starts at step 701.

At step 702, the second information processing apparatus 100B (which may be comprised within the Zapp Core 202B) receives a message from the first information processing apparatus 100A (which may be comprised within the payment gateway 203B). The message comprises information identifying the second party. The message may also comprise other information (e.g., information defining the MRT mandate).

At step 703, the second information processing apparatus 100B generates a code (e.g., PBBA code or ApTRId identifier) associated with the second party. More specifically, the code is associated with the message received from the first information processing apparatus 100A in step 702.

At step 704, the second information processing apparatus 100B transmits a message comprising the code to the first information processing apparatus 100A. If the code is a PBBA code, for example, it is displayed on a screen of the native merchant app 204A. If the code is an ApTRId identifier, it is not displayed.

At step 705, the third information processing apparatus 100C (which may be comprised within the payment gateway 201B) receives an authentication credential from the first party (e.g., via a passcode or biometric identifier entered via the MBA 201A).

At step 706, the third information processing apparatus 100C obtains the code. If the code is a PBBA code, for example, the consumer enters the PBBA code manually using the MBA 201A. If the code is an ApTRId identifier, for example, the ApTRId identifier is obtained by the MBA 201A from a Submit RTL Response message (in FIG. 4) or Submit RTP Response message (in FIG. 6).

At step 707, the third information processing apparatus 100C transmits a message comprising the code and information identifying the first party to the second information processing apparatus. This message is the Retrieve RTL message in FIG. 4 or the Retrieve RTP message in FIG. 6, for example.

At step 708, the second information processing apparatus 100B associates the first and second parties. This is done by associating the information identifying the first party with the information identifying the second party in a database stored in the storage medium 103B, for example. Other information associated with the first and second party (e.g., the MRT mandate) may also be stored.

At step 709, the second information processing apparatus 100B transmits a message comprising information indicating the association of the first and second parties to the third information processing apparatus 100C. The message may also comprise other information (e.g., the MRT mandate).

At step 710, the third information processing apparatus 100C receives approval of the association from the first party. This occurs when the user is provided with information indicating the association (e.g., to link their bank account with a merchant in accordance with the MRT mandate) and approves the association (e.g., by selecting the Authorize virtual button 306 in FIG. 3D).

At step 711, the third information processing apparatus 100C transmits a message comprising information indicating the approval of the association to the second information processing apparatus 100B. For example, this is the Confirm RTL message in FIG. 4 or the Confirm message in FIG. 6 (this also comprises the consumer's IBAN in these examples).

At step 712, the second information processing apparatus 100B transmits a message comprising information indicating the approval of the association to the first information processing apparatus 100A. For example, this is the Notify TRL message in FIG. 4 or the Notification message in FIG. 6 (this also comprises the consumer's tokenised IBAN in these examples).

The method ends at step 713.

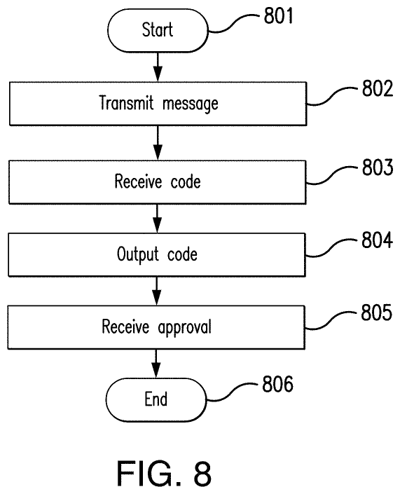

FIG. 8 shows parts of the information processing method of FIG. 7 carried out by the first information processing apparatus 100A.

The method starts at step 801.

At step 802, the communication interface 104A transmits the message comprising information identifying the second party (see step 702) to the communication interface 104B of the second information processing apparatus 100B.

At step 803, the communication interface 104A receives the message comprising the code associated with the second party (see step 704) from the communication interface 104B of the second information processing apparatus 100B.

At step 804, the communications interface 104 outputs the code. For example, the PBBA code is output for display on the consumer's terminal device using the merchant native app 204A or the ApTRId identifier is output for use by the MBA 201A directly.

At step 805, the communications interface 104A receives the message comprising information indicating approval of the association of the first and second parties (see step 712) from the communications interface 104B of the second information processing apparatus 100B.

The method ends at step 806.

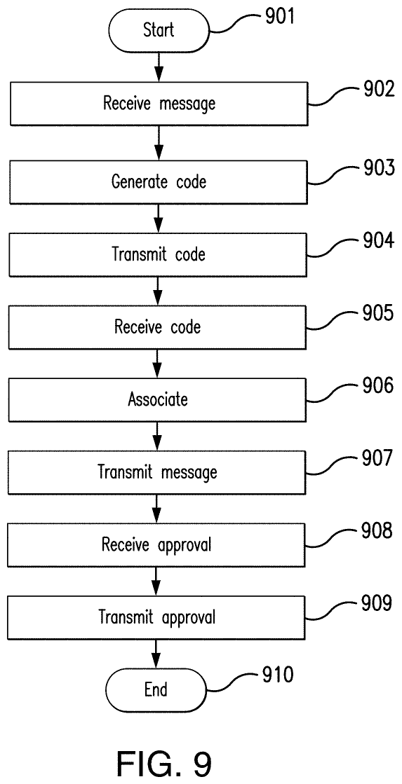

FIG. 9 shows parts of the information processing method of FIG. 7 carried out by the second information processing apparatus 100B.

The method starts at step 901.

At step 902, the communications interface 104B receives the message comprising information identifying the second party (see step 702) from the communications interface 104A of the first information processing apparatus 100A.

At step 903, the processor 101B generates the code associated with the second party (see step 703).

At step 904, the communications interface 104B transmits the message comprising the code (see step 704) to the communications interface 104A of the first information processing apparatus 100A.

At step 905, the communications interface 104B receives the message comprising the code and information identifying the first party (see step 707) from the communications interface 104C of the third information processing apparatus 100C.

At step 906, the processor 101B associates the first and second parties (see step 708).

At step 907, the communications interface 104B transmits the message comprising information indicating the association of the first and second parties (see step 709) to the communications interface 104C of the third information processing apparatus 100C.

At step 908, the communications interface 104B receives the message comprising information indicating the approval of the association (see step 711) from the communications interface 104C of the third information processing apparatus 100C.

At step 909, the communications interface 104B transmits the message comprising information indicating the approval of the association (see step 712) to the communications interface 104A of the first information processing apparatus 100A.

The method ends at step 910.

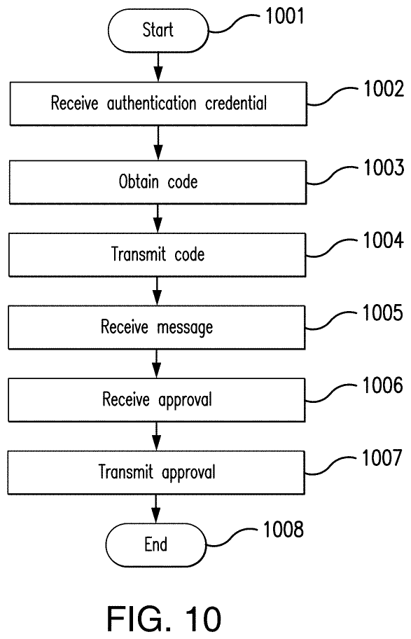

FIG. 10 shows parts of the information processing method of FIG. 7 carried out by the third information processing apparatus 100C.

The method starts at step 1001.

At step 1002, the communications interface 104C receives an authentication credential from the first party. The authentication credential is based on a passcode or biometric identifier entered via the MBA 201A, for example. The authentication credential may be information indicating the passcode or biometric identifier itself or may be information from the MBA 201A indicating the passcode or biometric identifier has been successfully entered.

At step 1003, the communications interface 104C obtains the code associated with the second party (see step 706). The code (e.g., PBBA code or ApTRId identifier) is obtained via the MBA 201A, for example.

At step 1004, the communications interface 104C transmits the message comprising the code and information identifying the first party (see step 707) to the communications interface 104B of the second information processing apparatus 100B.

At step 1005, the communications interface 104C receives the message comprising information indicating an association of the first and second parties (see step 709) from the communications interface 104B of the second information processing apparatus 100B.

At step 1006, the communications interface 104C receives approval of the association from the first party (see step 710). The approval is obtained via the MBA 201A, for example.

At step 1007, the communications interface 104C transmits the message comprising information indicating the approval of the association (see step 711) to the communications interface 104B of the second information processing apparatus 100B.

The method ends at step 1008.

The above embodiments explain the association between a merchant and a consumer to be established. In embodiments of the disclosure, the consumer may also delete the link between themselves and the merchant. In other words, in embodiments, the consumer will also be able to disassociate themselves from the merchant after making the association described above. In embodiments this is done whilst the consumer is within the merchant domain (for example on the payment page during checkout of whilst managing the linked payment options described above). This is a very convenient mechanism for the consumer to delete the link.

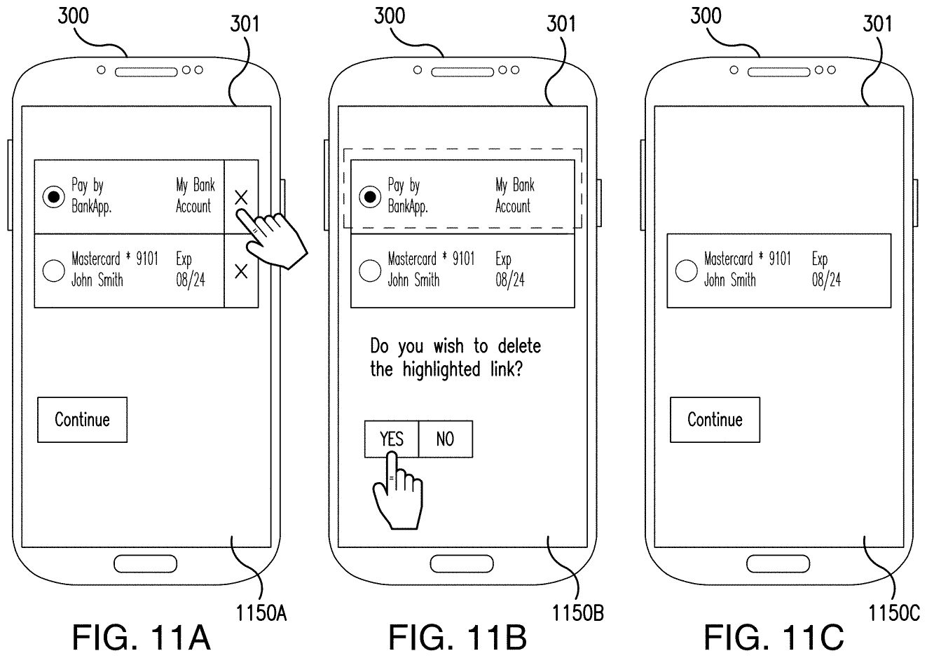

This disassociation will be described with reference to FIG. 11A and FIG. 11B.

FIG. 11A-11C show example screens of the MBA and merchant native app displayed on a display 301 of a terminal device 300 of a consumer (user) during some of the steps associated with the disassociation according to embodiments.

In FIG. 11A, the consumer logs into their merchant account. This merchant account displays the consumer's accounts that are associated with this merchant in 1150A. In other words, the consumer accounts that are linked with this merchant are shown. These accounts may be linked with the merchant in the manner described with reference to the above embodiments.

As will be apparent, in the example of FIG. 11A, two accounts are linked. Adjacent each linked account is an “x”. This “x” is a delete virtual button. Although an “x” is shown to indicate a delete button, the disclosure is not so limited and any appropriate icon is envisaged.

In order to being the process of deleting the link, the consumer presses the “x”. The process moves to FIG. 11B where the account being deleted is highlighted (in this case by the dashed lines surrounding the account) and the user is asked to confirm that the highlighted account is to be deleted. This is shown in 1150B. The user confirms the deletion of the highlighted account.

After the deletion of the association has taken place, the process then moves to step FIG. 11C where the consumer is shown the remaining linked accounts. This is shown in 1150C.

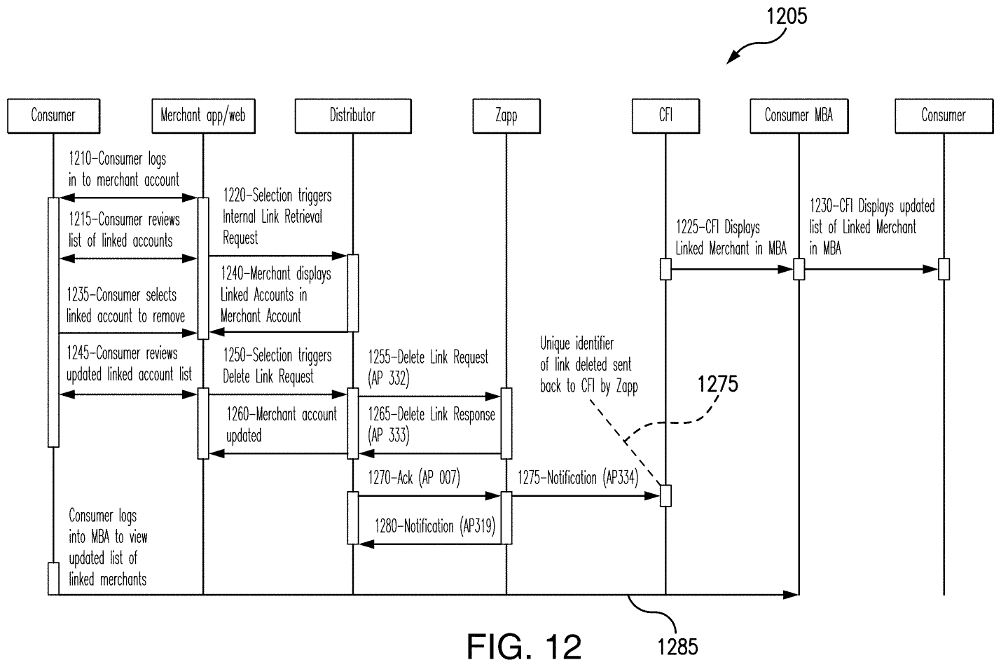

A signal flow diagram 1205 explaining the process for deleting the link is described with reference to FIG. 12.

Firstly, the consumer logs into the merchant account. This is step 1210. The consumer then reviews the list of linked accounts in step 1215. This is shown in FIG. 11A where the black dot is shown next to the account. The selection triggers an Internal Link Retrieval Request to the distributor in step 1220. The merchant displays the linked accounts in the Merchant Account in step 1240 within the consumer MBA. This is sent to the consumer MBA 201A by the CFI 201 in step 1225. The consumer selects the linked account to remove in step 1235. This is shown in FIG. 11A as the “x” adjacent the linked account. The consumer is asked to confirm the selection. When the selection is confirmed, a Delete Link Request is sent to the distributor in step 1250. The distributor sends a Delete Link Request to the ZAPP core where the selected consumer account is disassociated from the merchant. This is step 1255.

After the ZAPP core 202B deletes the link, a Delete Link Response is sent from the ZAPP core to the distributor. This is step 1265. The distributor then updates the merchant account in step 1260.

The distributor acknowledges the Delete Link Response in step 1270 which is sent to the ZAPP core 202B. The ZAPP core 202B then sends a notification to the CFI 201 in step 1275. The notification sent to the CFI provides the unique identifier that was deleted. The unique identifier may be any kind of identifier that identifies the association between the consumer and the merchant. For example, the unique identifier may be the tokenised IBAN and merchant identified in the Retrieve RTP Response message. This allows the CFI 201 to remove the link in accordance with the consumer's wishes. Moreover, this ensures that the CFI 201 keeps the trusted beneficiary list maintained in real-time. The ZAPP core 202B sends a notification to the distributor in step 1280.

In step 1285, the consumer logs into the MBA 201A. The CFI displays the updated list of Linked Merchant in the MBA 201A in step 1230.

By allowing the consumer to delete a linked account, this provides increased flexibility to the user.

Embodiments of the disclosure can be defined using the following numbered clauses.

1. An information processing system for associating a first party and a second party comprising:

a first information processing apparatus;

a second information processing apparatus configured to:
receive a message from the first information processing apparatus comprising information identifying the second party;
generate a code associated with the second party; and
transmit a message comprising the code to the first information processing apparatus; and

a third information processing apparatus configured to:
receive an authentication credential from the first party;
obtain the code;
transmit a message comprising the code and information identifying the first party to the second information processing apparatus;
wherein the second information processing apparatus is configured to:
   associate the first and second parties; and
   transmit a message comprising information indicating the association of the first and second parties to the third information processing apparatus;
wherein the third information processing apparatus is configured to:
   receive approval of the association from the first party; and
   transmit a message comprising information indicating the approval of the association to the second information processing apparatus;
   wherein the second information processing apparatus is configured to transmit a message comprising information indicating the approval of the association to the first information processing apparatus.

2. An information processing system according to clause 1, wherein the first party is a consumer, the second party is a merchant and the approved association allows the merchant to receive payments from the consumer.

3. An information processing system according to clause 2, wherein:

the third information processing apparatus is an information processing apparatus of a financial institution at which the consumer holds an account;

the second information processing apparatus is configured, after receiving the message comprising information indicating the approval of the association from the third information processing apparatus, to transmit a proxy identifier of the consumer to the first information processing apparatus, wherein the proxy identifier is associated with the financial institution, the merchant and the account of the consumer, information indicating the association between the proxy identifier and the financial institution is stored at the second information processing apparatus and information indicating the association between the proxy identifier, the merchant and the account of the consumer is stored at the third information processing apparatus;

the first information processing apparatus is configured to transmit a message comprising a request for payment from the consumer to the merchant to the second information processing apparatus, the message comprising the proxy identifier and information identifying the merchant;

the second information processing apparatus is configured to look up the financial institution using the proxy identifier and transmit a message comprising a request for payment from the consumer to the merchant to the third information processing apparatus, the message comprising the proxy identifier and information identifying the merchant; and

the third information processing apparatus is configured look up the account using the proxy identifier and initiate an electronic payment from the account to an account of the identified merchant when the identified merchant matches the merchant with which the proxy identifier is associated.

4. An information processing system according to clause 3, wherein the proxy identifier is a proxy International Bank Account Number, IBAN.

5. An information processing system according to clause 3 or 4, wherein the third information processing apparatus is configured to store information indicating a predetermined condition associated with the electronic payment and to initiate the electronic payment only if the predetermined condition is met.

6. An information processing system according to any one of clauses 3 to 5, wherein the third information processing apparatus is configured to store information indicating a predetermined condition associated with the electronic payment and, if the predetermined condition is met, to initiate the electronic payment only if a further authentication credential is received from the consumer.

7. An information processing system according to any preceding clause, wherein the third information processing apparatus is configured to receive the authentication credential from the first party and the code via a software application on a terminal device.

8. An information processing system according to any preceding clause, wherein the first information processing apparatus is configured to send a delete link request to the second information processing apparatus, the delete link request indicating that the association between the first and second parties is to be deleted; and in response, the second information processing apparatus is configured to send a notification to the third processing apparatus, the notification uniquely identifying the association between the first and second parties, wherein the third processing apparatus is configured to delete the association.

9. A first information processing apparatus for associating a first party and a second party comprising circuitry configured:

to transmit a message comprising information identifying the second party to a second information processing apparatus;

to receive a message comprising a code associated with the second party from the second information processing apparatus;

to output the code; and

to receive a message comprising information indicating approval of an association of the first and second parties from the second information processing apparatus.

10. A first information processing apparatus according to clause 9, wherein the first party is a consumer, the second party is a merchant and the approved association allows the merchant to receive payments from the consumer.

11. A first information processing apparatus according to clause 10, wherein the circuitry is configured to:

to receive a proxy identifier of the consumer from the second information processing apparatus, wherein the proxy identifier is associated with a financial institution at which the consumer holds an account, the merchant and the account of the consumer;

to transmit a message comprising a request for payment from the consumer to the merchant to the second information processing apparatus, the message comprising the proxy identifier and information identifying the merchant.

12. A first information processing apparatus according to clause 11, wherein the proxy identifier is a proxy International Bank Account Number, IBAN.

13. A second information processing apparatus for associating a first party and a second party comprising circuitry configured:

to receive a message comprising information identifying the second party from a first information processing apparatus;

to generate a code associated with the second party;

to transmit a message comprising the code to the first information processing apparatus;

to receive a message comprising the code and information identifying the first party from a third information processing apparatus;

to associate the first and second parties;

to transmit a message comprising information indicating the association of the first and second parties to the third information processing apparatus;

to receive a message comprising information indicating the approval of the association from the third information processing apparatus; and

to transmit a message comprising information indicating the approval of the association to the first information processing apparatus.

14. A second information processing apparatus according to clause 13, wherein the first party is a consumer, the second party is a merchant and the approved association allows the merchant to receive payments from the consumer.

15. A second information processing apparatus according to clause 14, wherein:

the third information processing apparatus is an information processing apparatus of a financial institution at which the consumer holds an account; and

the circuitry is configured:
after receiving the message comprising information indicating the approval of the association from the third information processing apparatus, to transmit a proxy identifier of the consumer to the first information processing apparatus, wherein the proxy identifier is associated with the financial institution, the merchant and the account of the consumer and the circuitry is configured to store information indicating the association between the proxy identifier and the financial institution;
to receive a message comprising a request for payment from the consumer to the merchant from the first information processing apparatus, the message comprising the proxy identifier and information identifying the merchant; and
to look up the financial institution using the proxy identifier and transmit a message comprising a request for payment from the consumer to the merchant to the third information processing apparatus, the message comprising the proxy identifier and information identifying the merchant.

16. A second information processing apparatus according to clause 15, wherein the proxy identifier is a proxy International Bank Account Number, IBAN.

17. A third information processing apparatus for associating a first party and a second party comprising circuitry configured:

to receive an authentication credential from the first party;

to obtain a code associated with the second party;

to transmit a message comprising the code and information identifying the first party to a second information processing apparatus;

to receive a message comprising information indicating an association of the first and second parties from the second information processing apparatus;

to receive approval of the association from the first party; and

to transmit a message comprising information indicating the approval of the association to the second information processing apparatus.

18. A third information processing apparatus according to clause 17, wherein the first party is a consumer, the second party is a merchant and the approved association allows the merchant to receive payments from the consumer.

19. A third information processing apparatus according to clause 18, wherein:

the third information processing apparatus is an information processing apparatus of a financial institution at which the consumer holds an account; and

the circuitry is configured:
after transmitting the message comprising information indicating the approval of the association to the second information processing apparatus, to store a proxy identifier of the consumer, wherein the proxy identifier is associated with the financial institution, the merchant and the account of the consumer, and to store information indicating the association between the proxy identifier, the merchant and the account of the consumer;
to receive a message comprising a request for payment from the consumer to the merchant from the second information processing apparatus, the message comprising the proxy identifier and information identifying the merchant; and
to look up the account using the proxy identifier and initiate an electronic payment from the account to an account of the identified merchant when the identified merchant matches the merchant with which the proxy identifier is associated.

20. A third information processing apparatus according to clause 19, wherein the proxy identifier is a proxy International Bank Account Number, IBAN.

21. A third information processing apparatus according to clause 19 or 20, wherein the circuitry is configured to store information indicating a predetermined condition associated with the electronic payment and to initiate the electronic payment only if the predetermined condition is met.

22. A third information processing apparatus according to any one of clauses 19 to 21, wherein the circuitry is configured to store information indicating a predetermined condition associated with the electronic payment and, if the predetermined condition is met, to initiate the electronic payment only if a further authentication credential is received from the consumer.

23. A third information processing apparatus according to any one of clause 19 to 22, wherein the circuitry is configured to receive the authentication credential from the first party and the code via a software application on a terminal device.

24. An information processing method for associating a first party and a second party comprising:

receiving, at a second information processing apparatus, a message from a first information processing apparatus comprising information identifying the second party;

generating, at the second information processing apparatus, a code associated with the second party; and

transmitting, from the second information processing apparatus, a message comprising the code to the first information processing apparatus;

receiving, at a third information processing apparatus, an authentication credential from the first party;

obtaining the code at the third information processing apparatus;

transmitting, from the third information processing apparatus, a message comprising the code and information identifying the first party to the second information processing apparatus;

associating the first and second parties at the second information processing apparatus; and

transmitting, from the second information processing apparatus, a message comprising information indicating the association of the first and second parties to the third information processing apparatus;

receive approval of the association from the first party at the third information processing apparatus; and

transmitting, from the third information processing apparatus, a message comprising information indicating the approval of the association to the second information processing apparatus; and

transmitting, from the second information processing apparatus, a message comprising information indicating the approval of the association to the first information processing apparatus.

25. An information processing method for associating a first party and a second party comprising:

transmitting, from a first information processing apparatus, a message comprising information identifying the second party to a second information processing apparatus;

receiving, at the first information processing apparatus, a message comprising a code associated with the second party from the second information processing apparatus;

outputting the code; and

receiving, at the first information apparatus, a message comprising information indicating approval of an association of the first and second parties from the second information processing apparatus.

26. An information processing method for associating a first party and a second party comprising:

receiving, at a second information processing apparatus, a message comprising information identifying the second party from a first information processing apparatus;

generating a code associated with the second party;

transmitting, from the second information processing apparatus, a message comprising the code to the first information processing apparatus;

receiving, at the second information processing apparatus, a message comprising the code and information identifying the first party from a third information processing apparatus;

associating the first and second parties;

transmitting, from the second information processing apparatus, a message comprising information indicating the association of the first and second parties to the third information processing apparatus;

receiving, at the second information processing apparatus, a message comprising information indicating the approval of the association from the third information processing apparatus; and

transmitting, from the second information processing apparatus, a message comprising information indicating the approval of the association to the first information processing apparatus.

27. An information processing method for associating a first party and a second party comprising:

receiving an authentication credential from the first party;

obtaining a code associated with the second party;

transmitting, from a third information processing apparatus, a message comprising the code and information identifying the first party to a second information processing apparatus;

receiving, at the third information processing apparatus, a message comprising information indicating an association of the first and second parties from the second information processing apparatus;

receiving approval of the association from the first party; and

transmitting, from the third information processing apparatus, a message comprising information indicating the approval of the association to the second information processing apparatus.

28. A program for controlling a computer to perform a method according to any one of clauses 24 to 27.

29. A non-transitory storage medium storing a program according to clause 28.

Numerous modifications and variations of the present disclosure are possible in light of the above teachings. It is therefore to be understood that within the scope of the appended claims, the disclosure may be practiced otherwise than as specifically described herein. In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

What is claimed is:

1. An information processing system for associating a first party and a second party comprising:
a first information processing apparatus;
a second information processing apparatus configured to:
receive a message from the first information processing apparatus comprising information identifying the second party;
generate a code associated with the second party; and
transmit a message comprising the code to the first information processing apparatus; and
a third information processing apparatus configured to:
receive an authentication credential from the first party;
obtain the code;
transmit a message comprising the code and information identifying the first party to the second information processing apparatus;
wherein the second information processing apparatus is configured to:
associate the first and second parties; and
transmit a message comprising information indicating the association of the first and second parties to the third information processing apparatus;
wherein the third information processing apparatus is configured to:
receive approval of the association from the first party; and
transmit a message comprising information indicating the approval of the association to the second information processing apparatus;
wherein the second information processing apparatus is configured to transmit a message comprising information indicating the approval of the association to the first information processing apparatus.

2. The information processing system according to claim 1, wherein the first party is a consumer, the second party is a merchant and the approved association allows the merchant to receive payments from the consumer.

3. The information processing system according to claim 2, wherein:
the third information processing apparatus is an information processing apparatus of a financial institution at which the consumer holds an account;
the second information processing apparatus is configured, after receiving the message comprising information indicating the approval of the association from the third information processing apparatus, to transmit a proxy identifier of the consumer to the first information processing apparatus, wherein the proxy identifier is associated with the financial institution, the merchant and the account of the consumer, information indicating the association between the proxy identifier and the financial institution is stored at the second information processing apparatus and information indicating the association between the proxy identifier, the merchant and the account of the consumer is stored at the third information processing apparatus;
the first information processing apparatus is configured to transmit a message comprising a request for payment from the consumer to the merchant to the second information processing apparatus, the message comprising the proxy identifier and information identifying the merchant;
the second information processing apparatus is configured to look up the financial institution using the proxy identifier and transmit a message comprising a request for payment from the consumer to the merchant to the third information processing apparatus, the message comprising the proxy identifier and information identifying the merchant; and
the third information processing apparatus is configured look up the account using the proxy identifier and initiate an electronic payment from the account to an account of the identified merchant when the identified merchant matches the merchant with which the proxy identifier is associated.

4. The information processing system according to claim 3, wherein the proxy identifier is a proxy International Bank Account Number (IBAN).

5. The information processing system according to claim 3, wherein the third information processing apparatus is configured to store information indicating a predetermined condition associated with the electronic payment and to initiate the electronic payment only if the predetermined condition is met.

6. The information processing system according to claim 3, wherein the third information processing apparatus is configured to store information indicating a predetermined condition associated with the electronic payment and, if the predetermined condition is met, to initiate the electronic payment only if a further authentication credential is received from the consumer.

7. The information processing system according to claim 1, wherein the third information processing apparatus is configured to receive the authentication credential from the first party and the code via a software application on a terminal device.

8. The information processing system according to claim 1, wherein the first information processing apparatus is configured to send a delete link request to the second information processing apparatus, the delete link request indicating that the association between the first and second parties is to be deleted; and in response, the second information processing apparatus is configured to send a notification to the third processing apparatus, the notification uniquely identifying the association between the first and second parties, wherein the third processing apparatus is configured to delete the association.

9. A second information processing apparatus for associating a first party and a second party comprising circuitry configured to:
receive a message comprising information identifying the second party from a first information processing apparatus;
generate a code associated with the second party;
transmit a message comprising the code to the first information processing apparatus;
receive a message comprising the code and information identifying the first party from a third information processing apparatus;
associate the first and second parties;
transmit a message comprising information indicating the association of the first and second parties to the third information processing apparatus;
receive a message comprising information indicating approval of the association from the third information processing apparatus; and
transmit a message comprising information indicating the approval of the association to the first information processing apparatus.

10. The second information processing apparatus according to claim 9, wherein the first party is a consumer, the second party is a merchant and the approved association allows the merchant to receive payments from the consumer.

11. The second information processing apparatus according to claim 10, wherein:
the third information processing apparatus is an information processing apparatus of a financial institution at which the consumer holds an account; and
the circuitry is configured to:
after receiving the message comprising information indicating the approval of the association from the third information processing apparatus, transmit a proxy identifier of the consumer to the first information processing apparatus, wherein the proxy identifier is associated with the financial institution, the merchant and the account of the consumer and the circuitry is configured to store information indicating the association between the proxy identifier and the financial institution;
receive a message comprising a request for payment from the consumer to the merchant from the first information processing apparatus, the message comprising the proxy identifier and information identifying the merchant; and
look up the financial institution using the proxy identifier and transmit a message comprising a request for payment from the consumer to the merchant to the third information processing apparatus, the message comprising the proxy identifier and information identifying the merchant.

12. The second information processing apparatus according to claim 11, wherein the proxy identifier is a proxy International Bank Account Number (IBAN).

13. An information processing method for associating a first party and a second party comprising:
receiving, at a second information processing apparatus, a message from a first information processing apparatus comprising information identifying the second party;
generating, at the second information processing apparatus, a code associated with the second party; and
transmitting, from the second information processing apparatus, a message comprising the code to the first information processing apparatus;
receiving, at a third information processing apparatus, an authentication credential from the first party;
obtaining the code at the third information processing apparatus;
transmitting, from the third information processing apparatus, a message comprising the code and information identifying the first party to the second information processing apparatus;
associating the first and second parties at the second information processing apparatus; and
transmitting, from the second information processing apparatus, a message comprising information indicating the association of the first and second parties to the third information processing apparatus;
receive approval of the association from the first party at the third information processing apparatus; and
transmitting, from the third information processing apparatus, a message comprising information indicating the approval of the association to the second information processing apparatus; and
transmitting, from the second information processing apparatus, a message comprising information indicating the approval of the association to the first information processing apparatus.

14. The information processing method according to claim 13, wherein the first party is a consumer, the second party is a merchant and the approved association allows the merchant to receive payments from the consumer.

15. The information processing method according to claim 14, wherein the third information processing apparatus is an information processing apparatus of a financial institution at which the consumer holds an account, the method further comprising:
after receiving the message comprising information indicating the approval of the association from the third information processing apparatus, transmitting from the second information processing apparatus, a proxy identifier of the consumer to the first information processing apparatus, wherein the proxy identifier is associated with the financial institution, the merchant and the account of the consumer, wherein information indicating the association between the proxy identifier and the financial institution is stored at the second information processing apparatus, and wherein information indicating the association between the proxy identifier, the merchant and the account of the consumer is stored at the third information processing apparatus;
transmitting, from the first information processing apparatus, a message comprising a request for payment from the consumer to the merchant to the second information processing apparatus, the message comprising the proxy identifier and information identifying the merchant;
performing, by the second information processing apparatus a look up of the financial institution using the proxy identifier;
transmitting, by the second information processing apparatus, a message comprising a request for payment from the consumer to the merchant to the third information processing apparatus, the message comprising the proxy identifier and information identifying the merchant; and
performing, by the third information processing apparatus, a look up of the account using the proxy identifier and initiate an electronic payment from the account to an account of the identified merchant when the identified merchant matches the merchant with which the proxy identifier is associated.
